(19) United States
(12) Patent Application Publication
(10) Pub. No.: US 2014/0377008 A1
(43) Pub. Date: Dec. 25, 2014

(54) Controlling processes for evaporative desorption processes

(71) Applicant: RETERRO, INC., Pleasanton, CA (US)

(72) Inventors: Brian Desmarais, Kenebunk, ME (US); Patrick Richard Brady, Sisters, OR (US); Steve Bay, Pleasanton, CA (US)

(21) Appl. No.: 14/312,624

(22) Filed: Jun. 23, 2014

Related U.S. Application Data
(60) Provisional application No. 61/838,337, filed on Jun. 23, 2013.

(51) Int. Cl. B09C 1/06

(52) U.S. Cl. CPC B09C 1/06
USPC 405/128.85

(57) ABSTRACT

Active or closed loop controls can be used to improve the operation of a thermal desorption process. Characteristics of the thermal desorption process can be monitored, and then can be used to predict the end point of the thermal desorption process. Inputs and effluent treatment elements can also be modulated to further optimize the treatment time and quality (completeness) and to avoid any unwanted effects associated with excess processing.

This application claims priority from U.S. provisional patent application Ser. No. 61/838,337, filed on Jun. 23, 2013, entitled “Controlling processes for evaporative desorption processes”, which is incorporated herein by reference.

### BACKGROUND

The use of petroleum hydrocarbons as a fuel source is ubiquitous in society. Consequently, petroleum hydrocarbon products are stored and handled in great quantities. One risk associated with the storage and handling of petroleum hydrocarbons is the potential for spillages during handling or the potential for leakage during storage. Due to the negative environmental impact associated with spills and leakages of petroleum hydrocarbons, rules have been established at the local, state and federal levels. These rules primarily focus on preventing petroleum hydrocarbon releases to the environment from occurring. These rules also have provisions that require the responsible party to remediate petroleum hydrocarbon releases to the environment.

In the field of petroleum hydrocarbon remediation from soil, there are two basic approaches: applying a treatment technique to soil in place (in-situ), or applying a treatment technique to excavated soil (ex-situ). There are advantages and disadvantages for each approach and the selection of the approach is based on the site-specific circumstances of each petroleum hydrocarbon release.

Ex-situ thermal desorption technologies can include techniques that involve mechanical agitation of the soil during the heating process, which involve mechanical agitation and operate in a continuous process where the soil is continuously introduced to the process and is mechanically moved through the process apparatus until treatment is complete, and then is continuously discharged to a container for disposal or re-use.

Alternately, the soil can be treated in a static configuration, in which a given amount of soil is introduced to the treatment chamber. The soil configurations can include pile arrangement and container arrangements.

Nearly all the prior art processes use combustion of fossil fuel as a heat source. This can have the undesirable consequence of forming products of incomplete combustion, oxides of nitrogen, and other greenhouse gases as a by-product. Combustion also has the potential to add unburned hydrocarbons to the process exhaust gas if strict control of the combustion process is not maintained.

There can a need for an ex-situ static process that is labor, time and energy efficient in the treatment process, and is environmentally friendly.

### SUMMARY

A thermal desorption process can be used to treat contaminated soil in static arrangement, which is inherently safe, for example, due to the absence of open flame heating. In an evaporative desorption process, an input gas, such as air, can be heated and directed into a container of contaminated soil. The contaminants within the soil are evaporated and the process effluent is directed to a variety of collection or destruction systems.

In some embodiments, systems and methods are provided for controlling inputs to a thermal desorption chamber, for example, controlling a flow rate or a temperature of an input gas, to improve the efficiency of the treatment process, such as shortening the process time, minimizing the power consumption, or preventing overload conditions such as exceeding an operating temperature of the effluent treatment equipment.

In some embodiments, automatic operations of a thermal desorption process are provided. The suitability or completeness of the treatment can be determined by analyzing the output of these instruments and to automatically cease processing at the optimum moment to conserve energy and limit costs.

In some embodiments, active or closed loop controls of a thermal desorption process are provided. Characteristics of the thermal desorption process can be monitored, and then can be used to predict the end point of the thermal desorption process. Inputs and effluent treatment elements can also be modulated to further optimize the treatment time and quality (completeness) and to avoid any unwanted effects associated with excess processing.

In some embodiments, feed forward process optimizations of a thermal desorption process are provided. Processing data from a previous batch or series of batches can be used to formulate or to develop self-correcting or learning algorithms, that can be used to modulate the input or effluent to further optimize the subsequent processing parameters using statistical process control computations. This data may be combined with pre-treatment sample results to create a predictive process optimization. In addition, pre-treatment sample results may be used without batch processing data to obtain a similar predictive process optimization.

In some embodiments, low humidity gas can be used in an evaporated desorption process. The low humidity gas can improve, e.g., shorten, the process time of decontaminating the contaminated soil, for example, by absorbing more liquid vapor from the contaminated soil. The low humidity gas can be less than 20% humidity, such as less than 10% humidity or 5% humidity.

In some embodiments, the input gas to the thermal desorption chamber can have a two step characteristic. In the beginning, the input gas can have high temperature and low flow rate. The high temperature can speed up the heating of the contaminated soil. The low flow rate can improve the efficiency of the transfer of thermal energy from the input gas to the contaminated soil. After the soil is heated, for example, when the temperature of the exhaust gas reaches a certain temperature such as between 150 and 250 F (or between 200 and 220 F, or about 212 F), the input gas can have lower temperature and higher flow rate. The high flow rate can shorten the process time, for example, by quickly transport the evaporated contamination from the soil to the exhaust pipe. The low temperature can reduce the power consumption of the thermal desorption process, and does not affect, or minimally affect, the speed of the thermal desorption process, for example, due to the generated thermal energy from the contaminated hydrocarbons in the contaminated soil.

In some embodiments, characteristics of the thermal desorption process, such as temperature, the oxygen concentration, the pressure, the gas constituents, the humidity, the flammability of the effluent gas (e.g., the exhaust gas), can be monitored and then used to optimize the thermal desorption process.

### BRIEF DESCRIPTION OF THE DRAWINGS

FIG. 1 illustrates a schematic evaporative desorption system according to some embodiments.

FIG. 2 illustrates a thermal desorption chamber according to some embodiments.

FIGS. 3A-3C illustrate flowcharts for thermal desorption processes according to some embodiments.

FIG. 4 illustrates a thermal desorption chamber according to some embodiments.

FIG. 5 illustrates a two step characteristic of an input gas of a thermal desorption process according to some embodiments.

FIGS. 6A-6C illustrate flowcharts for thermal desorption processes according to some embodiments.

FIGS. 7A-7C illustrate flowcharts for thermal desorption processes according to some embodiments.

FIG. 8 illustrates temperature and oxygen concentration curves of an exhaust of a thermal desorption process according to some embodiments.

FIG. 9 illustrates temperature and oxygen concentration curves of an exhaust of a thermal desorption process according to some embodiments.

FIG. 10 illustrates temperature and oxygen concentration curves of an exhaust of a thermal desorption process according to some embodiments.

FIGS. 11A-1 lB illustrate flowcharts for thermal desorption processes according to some embodiments.

FIGS. 12A-12B illustrate flowcharts for thermal desorption processes according to some embodiments.

### DETAILED DESCRIPTION

In some embodiments, the invention relates to a process and apparatus for non-combustive thermal desorption of volatile contaminates from contaminated earth. The earth may include tar sand, oil sand, oil shale, bitumen, pond sediment, and tank bottom sediment. The concentration of the contaminates can be low concentration, e.g., less than about 3%, such as less than about 50,000 mg/kg of total petroleum hydrocarbon (TPH) in soil, or high concentration, e.g., greater than about 3%, such as greater than about 50,000 mg/kg of TPH in soil. The process can provide cracking of the contaminates, and/or reclaiming condensable contaminates, then oxidizing and treating the non-condensable reclamation effluent, which can be recycled for use as the thermal desorption treatment gas.

The non-combustive thermal desorption of volatile contaminates from low concentration contaminated earth is described in U.S. Pat. No. 6,829,844 (Brady et al) which is incorporated herein by reference in its entirety. The thermal desorption can remove organic contamination from porous media such as soil, rock, clays or other porous media with low organic contamination (less than 3% organic contamination) where desiccated electrically heated atmospheric air is used as the primary treatment gas. High organic contamination (greater than 3%) can use an inert or low oxygen (<9 vol % oxygen) treatment gas to minimize or prevent explosions, at the expense of longer processing times as well as larger capacity downstream air handling and treatment equipment.

In some embodiments, disclosed are systems and methods for treating contaminated soil in practically all levels of organic contaminations at high throughput with any level oxygen content treatment gas. For example, at high oxygen content treatment gas, a safe conveyance of the treated vapor between the treatment chamber and the downstream processing equipment can be implemented to reduce the explosion hazards.

In some embodiments, disclosed are systems and methods to operate thermal desorption systems with improved performance, such as higher throughput, e.g., shorter process time, low power consumption, and high reliability. For example, various automatic operations for a thermal desorption process are disclosed, which can enhance performance of the thermal desorption process. Low humidity input gas can be used in a thermal desorption process, which can result in shorter process time, e.g., faster contaminant removal from a contaminated soil. For example, less than 10% humidity input gas can show improvement over 20% humidity input gas. Also, 5% humidity input gas can further show significantly improvement. Low humidity input gas can be achieved with desiccant, for example, before or after heating.

Alternatively or in conjunction with low humidity input, two or more step processes can be used for improving the performance of a thermal desorption process. In a first step, high temperature and optional low flow input gas can be used. The temperature of the input gas can be a maximum temperature, for example, achieved by applying a maximum power to a heating system to heat the input gas. The high temperature input gas can quickly heat up the contaminated soil, which can shorten the process time as compared to low temperature input gas.

Optional low flow input gas can be used. The low flow can provide better heat transfer from the input gas to the contaminated soil, thus can improve, e.g., reduce, the power consumption of the thermal desorption process. The low flow input gas can have a negative effect on the process throughput, such as slower heating as compared to higher flow input gas. Thus an optimization for the flow rate of the input gas can be used, in which the input gas flow rate is selected based on a desired performance of the thermal desorption process, such as higher throughput (e.g., high flow rate) or lower power consumption (e.g., lower flow rate).

In a second step, lower temperature and optional higher flow input gas can be used. The temperature of the input gas can be reduced without significantly affecting the performance of the thermal desorption process, for example, due to the additional heat generated from the oxidation of the petroleum hydrocarbon contamination in the contaminated soil. Thus for high concentration of petroleum hydrocarbon contamination, the power heating the input gas can be turned off, with the contamination in the soil providing the needed thermal energy. For low concentration of petroleum hydrocarbon contamination, the power heating the input gas can be reduced, such as by 10 to 80%, depending on the generated heat by the contamination.

Optional higher flow input gas can be used. The high flow can provide better process throughput by a high reaction rate with the contaminants. In some embodiments, the input flow can be a maximum value, for example, as determined by a blower providing the input flow, or by a capacity of the exhaust treatment from the thermal desorption chamber. The high flow input gas can be advantageous, especially for the high concentration contaminated soil. The heater turned off, the high flow input gas can consume minimal power and can significantly improve the throughput of the thermal desorption process.

In some embodiments, disclosed are active or closed loop controls of a thermal desorption process. For example, the suitability or completeness of the contaminated soil treatment can be determined by analyzing the output of the thermal desorption process and to automatically cease processing at the optimum moment to conserve energy and limit costs. Different characteristics of the thermal desorption process can be monitored, such as temperature, the oxygen concentration, the pressure, the gas constituents, the humidity, the flammability of the effluent gas (e.g., the exhaust gas). The monitored characteristics can be used to optimize the thermal desorption process, such as to predict the end point of the thermal desorption process. Inputs to the thermal desorption process, together with effluent treatment elements can be modulated in response to the monitored characteristics to further optimize the treatment time and quality (completeness).

In some embodiments, processing data from a previous batch or series of batches can be used, in addition to the data from the current process. For example, data from the previous processes can be used to formulate or to develop self-correcting or learning algorithms, such as using a running average, instead or in addition to, the currently measure data. This data can be used to modulate the input or effluent to further optimize the subsequent processing parameters using statistical process control computations. In some embodiments, data from pre-treatment samples can be collected and used.

In some embodiments, the present invention, an evaporative desorption and/or reclamation process, can be cost effectively constructed to any scale and can exceed the 10 ton per hour production rate of indirect rotary kilns. The method can use non combustive heat in the treatment chamber, and rely on hot air moving through a static volume of porous media. The method can provide uniform heating of the soil/porous media with no mixing mechanisms for the porous media required for treatment. The process can provide efficient heat transfer to the soil/porous media, and can provide ancillary heat to heat the soil/porous media through an oxidation reaction that takes place within the soil/porous media, for example, through hydrocarbon cracking that takes place within the crude oil contaminated soil. In addition the process can recycle its heated treatment gas supply, minimizing energy required for treatment.

In some embodiments, the invention relates to a process and apparatus for thermal desorption of contaminates from a mixture of soil and rocks using desiccated, non-combustion-heated fresh treatment gas, such as air, to treat the soil and rocks which have been excavated and placed in a thermally conductive treatment container which is then placed in a thermally insulated treatment chamber. The fresh, hot, desiccated air is drawn through the soil treatment container, cooled, and released; or discharged to a treatment system, as required or needed, prior to release to the atmosphere.

In some embodiments, a thermal desorption technique applied to a static configuration of contaminated soil using a container arrangement is provided. The thermal desorption technique can restore the soil to its un-contaminated condition by removing the contamination within the soil through the evaporative desorption process. To provide an efficient remediation process, different temperature settings can be used to treat different contaminated soil, and thus sample of the contaminated soil can be tested to determine appropriate treatment conditions.

The treatment process for thermal desorption of hydrocarbon contaminants from excavated soil provides efficient contaminant removal by handling the soil in a thermally conductive soil box that is contained in an insulated treatment chamber for treatment. The soil is treated with dry hot air to remove contaminants, and the decontaminated soil can be returned to the ground.

In some embodiments, systems and methods are provided to supply thermal desorption of hydrocarbon contaminants from excavated soil, such as tar sand, oil sand, oil shale, bitumen, pond sediment, and tank bottom sediment. The systems can provide efficient contaminant removal by handling the soil in a thermally conductive soil box that fits within an insulated treatment chamber. The soil is treated in this chamber with hot dry treatment gas. The contaminates can be reclaimed from the soil box. A portion of the contaminates, such a non-condensable hydrocarbon contaminates, can be used for effluent conditioning, for example, to maintain a desired treatment gas temperature in the soil box.

Contaminated earth (soil and rocks or other earthy material) that has been excavated is placed in a thermally conductive soil box which is then placed in a thermally insulated treatment chamber. Heated treatment gases can be introduced to the soil box and flow through the soil box and the contaminated earth. Hot gas extraction, e.g., treatment gases containing contaminates, can be withdrawn from the treatment chamber. The process is continued until the contaminates are completely removed from the soil, e.g., below a desired contamination level.

In some embodiments, the contaminates can be reclaimed from the hot gas extraction, for example, through a heat exchanger to cool and separate the condensable contaminates. The remaining hot gas extraction can be treated in a combustion or electrically heated thermal oxidizer, for example, to remove non-condensable contaminates. The output from the thermal oxidizer can be partially recycled to the treatment chamber as the treatment gas, or to maintain the temperature of the treatment chamber.

The soil box can have sides to contain the contaminated soil. For example, the soil box can be an open top rectangular cube, prism or cylinder. The soil box can also have a gas exit pathway within the contaminated soil so that gases in the contaminated soil flow to the gas exit pathway.

The treatment chamber can have an opening so the soil box may be inserted or removed, a gas inlet to receive hot dry gas, which can be directed to the soil box, and a gas outlet arranged to be mated with the gas exit pathway of the soil box so the gases in the contaminated soil exit the treatment chamber.

A heater and drier assembly can be arranged so that the incoming treatment gas to the treatment chamber is dried and heated upon entering the treatment chamber. A blower assembly can be arranged to direct the hot gas extraction from the soil box to exit the treatment chamber.

Dry, heated incoming treatment gas can be provided to the soil box, for example, to the opening of the soil box and/or to the sides of the soil box, to transferring heat to the contaminated soil, inducing the migration of contaminates through the soil to the gas exit pathway. The heated treatment gas flows through the contaminated soil, directly heating the soil before entering the gas exit pathway and exiting the chamber, carrying the contaminates.

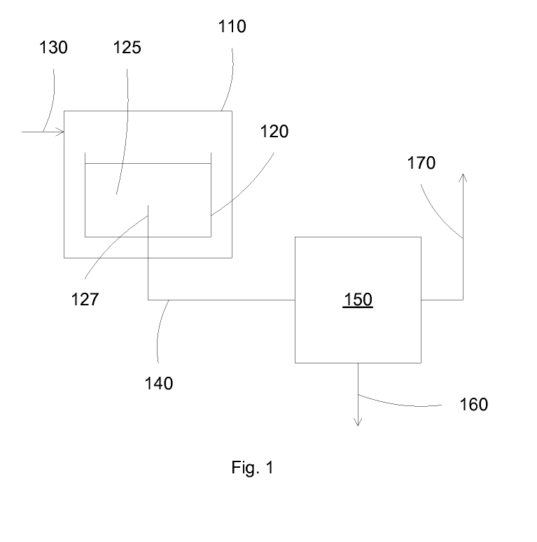

FIG. 1 illustrates a schematic evaporative desorption system according to some embodiments. One or more soil boxes 120 can be placed in a treatment chamber 110. The treatment chamber can be insulated to prevent heat loss. The soil boxes can be open on top and contain a gas exit pathway 127. The soil boxes, after filled with contaminated soil, can be installed in the treatment chamber 110 for contamination treatment, and can be removed after the contamination treatment is complete. The soil boxes can provide for a batch process for contaminated soil and clean soil. Hot and dry treatment gas 130 can be introduced to the treatment chamber 110. The treatment gas can pass through the contaminated soil in the soil box to the gas exit pathway 127 coupled to the treatment chamber exhaust 140, and then flow out of the treatment chamber 110.

The exhausted treatment gas can contain hydrocarbon contaminates, which can be recovered. A recovering assembly 150 can be coupled to the treatment chamber exhaust 140 to recover all or a portion of the hydrocarbons in the exhaust treatment gas. The recovering assembly 150 can include one or more heat exchangers and a gas extraction fan, which provides the flow of treatment gas from the treatment chamber 110 through the heat exchangers. The contaminates can be condensed and flow to a phase separator to recover the condensate from heat exchangers. Heavy organics, light organics, and water can be separated in the phase separator and flow 160 through the outlets to collection tanks. Remaining residues can be exhausted 170 to a vent stack.

In some embodiments, disclosed are process conditions for improving a thermal desorption process. For example, low humidity gas can be used to shorten the process time a thermal desorption process. The low humidity gas can be less than 20% humidity, such as less than 10% humidity or less than 5% humidity. Low humidity input gas can be achieved with desiccant, for example, before or after heating.

In a thermal desorption process, the ambient area may be monitored by a plurality of instruments whose outputs are fed to a control device, computer, PLC etc. Similarly the process effluent stream and the effluent processing system may be monitored. Instruments include a variety of mechanical and electronic detectors that measure temperature, pressure, gas constituents, humidity, flammability etc.

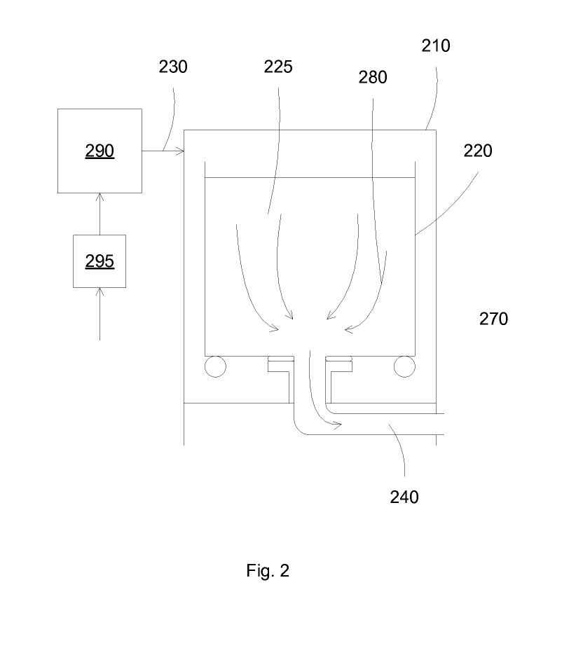

FIG. 2 illustrates a thermal desorption chamber according to some embodiments. The soil box 220 is a removable, sometimes called a roll-off, hopper modified to contain the gas exit pathway. The open-top soil box 220 can be supported by rollers or steel rails (not shown) in the bottom. The treatment chamber 210 can accept a hot and dry treatment gas 230, such as desiccated air. The treatment gas can enter the soil 225, flow 280 toward the gas exit pathway, carrying away the contaminants within the soil to the exhaust line 240. The treatment chamber 210 can be thermal insulated. The soil box 220 contains a gas exit pathway located near the bottom of the soil box. The gas exit pathway can be perforated to allow flow of treatment gas from the surrounding soil into the pathway. The soil box 220 can be installed on a pedestal soil box support that provides a flow path from the soil box gas exit pathway to provide for treatment gas and contaminants from the treatment chamber to exit 240 the chamber.

A heater/blower assembly 290 can be configured to provide the dry hot treatment gas 230 to the thermal desorption chamber 210. A desiccant unit 295 can be used to lower the humidity of the input gas to the heater/blower unit 290. Alternatively, the desiccant unit 295 can be located after the heater/blower unit 290. By lower the humidity of the input gas to below 10% or below 5% humidity level, significantly faster desorption of the contaminants can be achieved.

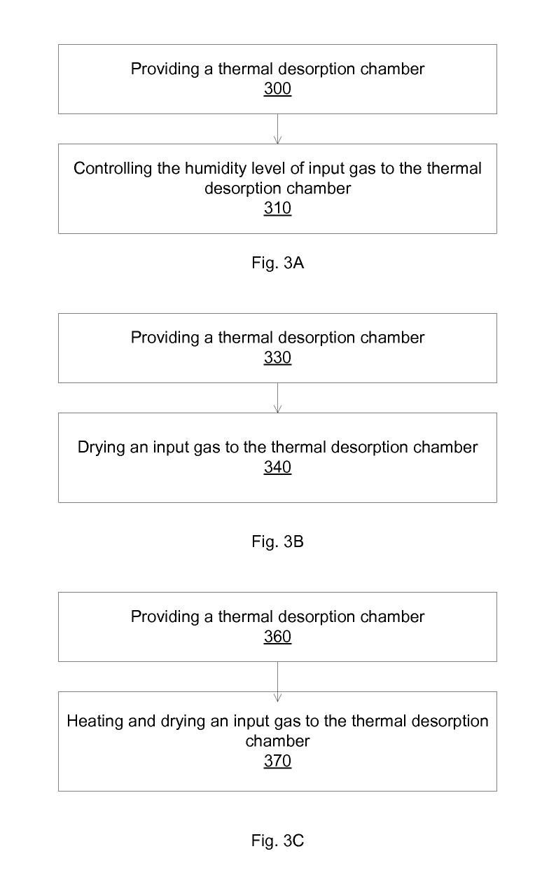

FIGS. 3A-3C illustrate flowcharts for thermal desorption processes according to some embodiments. In FIG. 3A, operation 300 provides a thermal desorption chamber, such as a container filled with contaminated soil. The thermal desorption chamber can accept a heated input gas for desorbing the contaminants from the soil. In operation 310, the humidity level of the input gas is controlled to achieve a performance improvement of the thermal desorption process. The humidity level of the input gas can be controlled to be less than 10% or less than 5%.

In FIG. 3B, operation 330 provides a thermal desorption chamber. In operation 340, an input gas to the thermal desorption chamber is dried to achieve a performance improvement of the thermal desorption process. The input gas can also be heated, either before or after being dried. The input gas can be dried to have less than 10% humidity or less than 5% humidity.

In FIG. 3C, operation 360 provides a thermal desorption chamber. In operation 370, an input gas to the thermal desorption chamber is dried and heated to achieve a performance improvement of the thermal desorption process. The input gas can be dried to have less than 10% humidity or less than 5% humidity. The input gas can be heated to a temperature of less than 1200 F or less than 1000 F.

In some embodiments, feed back control for a thermal desorption process are provided, for example, to conserve energy, limit costs, and achieve high throughput. For example, temperature of the exhaust gas can be monitored, and can be used to regulate the flow rate and temperature of the input gas. Alternatively or in addition, feed forward process optimizations can be used. Exhaust temperature curves from previous batches can be used to assist the currently measured exhaust temperature to provide better performance.

In some embodiments, systems and methods are provided to regulate an input gas, e.g., temperature and flow rate, to a thermal desorption chamber. The regulation can be based on time, on data from previous processes, or on measured temperature of the exhaust gas of the thermal desorption chamber. A temperature measurement device, such as a thermocouple, can be placed at or near the exhaust line of the thermal desorption chamber to measure the temperature of the treatment gas that exits the chamber. The measured temperature can be used to control a thermal energy input to the thermal desorption chamber, for example, by regulating a heater that heats the input gas or regulate a blower that controls the flow of the input gas. The contaminants can include different types of hydrocarbons, so a temperature between 250 F and 150 F, such as 212 F, can be used to change the flow rate or the temperature of the input gas.

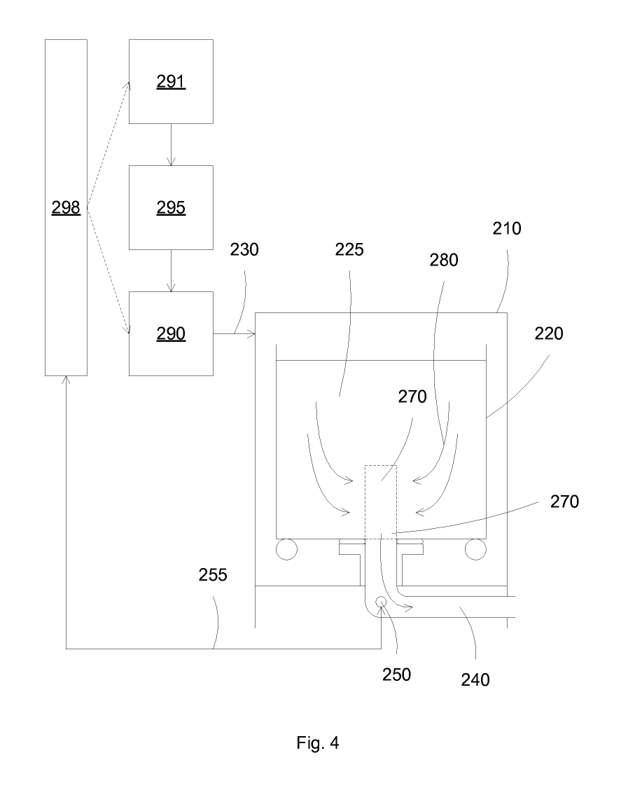

FIG. 4 illustrates a thermal desorption chamber according to some embodiments. The soil box 220 is a removable, sometimes called a roll-off, hopper modified to contain the gas exit pathway 270. The open-top soil box 220 can be supported by rollers or steel rails (not shown) in the bottom. The treatment chamber 210 can accept a hot and dry treatment gas 230, such as desiccated air. The treatment gas can enter the soil 225, flow 280 toward the gas exit pathway 270, carrying away the contaminants within the soil to the exhaust line 240. The treatment chamber 210 can be thermal insulated. The soil box 220 contains a gas exit pathway 270 located near the bottom of the soil box. The gas exit pathway can be perforated to allow flow of treatment gas from the surrounding soil into the pathway. The soil box 220 can be installed on a pedestal soil box support that provides a flow path from the soil box gas exit pathway 270 to provide for treatment gas and contaminants from the treatment chamber to exit 240 the chamber.

A thermocouple 250 can be placed in the exhaust line 240, such as at or near the exit at the thermal desorption chamber 210. A feedback 255 can be provided to a controller 298, which can be configured to control or regulate a blower assembly 291 and/or a heater assembly 290. Desiccant assembly 295 can be optionally used to lower the humidity of the input gas 230. The blower assembly 291 can be configured to provide a desired flow rate of input gas 230 to the thermal desorption chamber 210. The heater assembly 290 can be configured to heat the input gas for providing a dry hot treatment gas 230 to the thermal desorption chamber 210.

The feedback 255 can be used to regulate, e.g., increasing or decreasing, a thermal energy provided to heat the treatment gas input 230. For example, at the beginning of a treatment cycle, the exhaust temperature at the thermocouple 250 can be low, and a heater in the heater/blower assembly 290 can be turned on to heat the treatment gas 230. When the exhaust temperature exceeds a set point, the heater power can be reduced or turned off. The set point temperature can be pre-determined before the treatment, for example, by assessing the characteristics of the contaminated foil through a sample run. The set point temperature can be determined from previous runs, for example, by continuously collecting the characteristics of the contaminated foil in previous batches. In general, a set point temperature between 100 and 300 F, or between 150 and 250 F, or between 220 and 230 F can be used.

In some embodiments, the characteristics of the input gas to the thermal desorption chamber can be regulated, for example, based on process time, on temperature of the exhaust gas, on data from previous processes, or on data from the current process. The regulated characteristics of the input gas can include the temperature and the flow rate. For example, the temperature of the input gas can be regulated by controlling a power of a heater assembly used to heat the input gas. The flow rate of the input gas can be regulated by controlling a power or speed of a blower assembly used to provide the input gas.

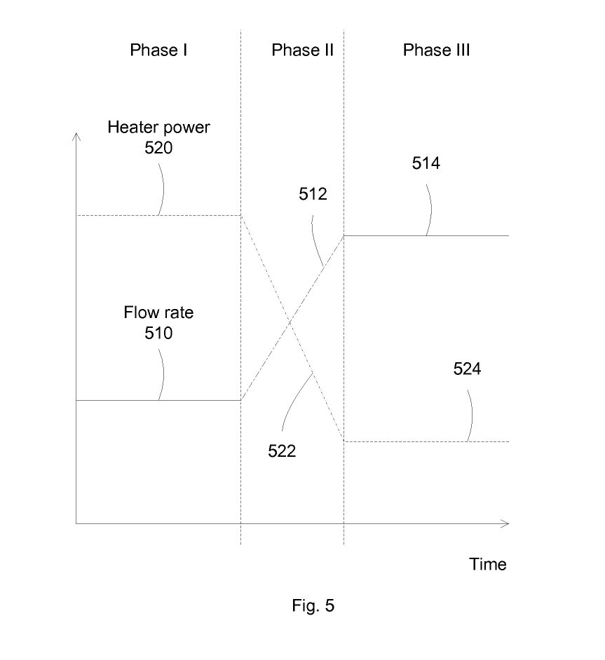

FIG. 5 illustrates a two step characteristic of an input gas of a thermal desorption process according to some embodiments. In Phase I, the input gas can have high temperature 520 and low flow rate 510. After the soil is heated, in Phase III, the input gas can have lower temperature 524 and higher flow rate 514. In Phase II, the temperature 522 and the flow rate 512 can be transitioned from high value to low value (for temperature) or from low value to high value (for flow rate). The variation of temperature can be achieved by varying the power of the heater assembly.

In some embodiments, the temperature (or the heater power) can be maximum in Phase I. In Phase III, the temperature can be reduced, for example, by turning off the heater power or by reducing the heater power to be between 80% and 20% of the maximum heater power. The flow rate can be maximum in Phase III, limited by either the blower capability or the effluent treatment capability. In Phase I, the flow rate can be less, such as between 80% and 20% of the maximum flow rate. In Phase II, linear transitions can be used for the temperature and the flow rate. Other configurations can be used, for example, the flow rate can be constant, e.g., maximum value, in all phases. Multiple phases can also be used, such as more regulation or control of temperature and/or flow rate, for example, to optimize a performance of the thermal desorption process.

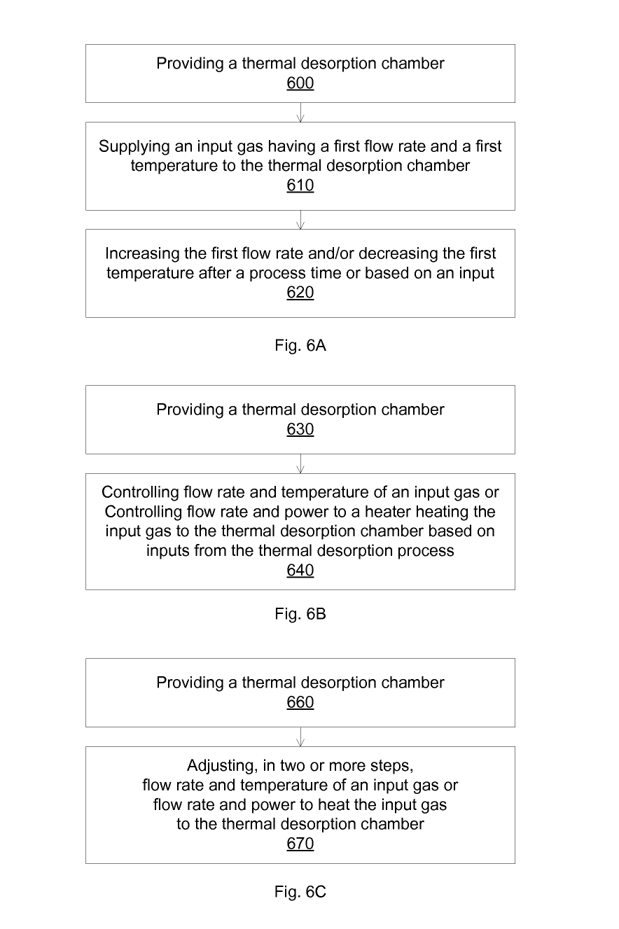

FIGS. 6A-6C illustrate flowcharts for thermal desorption processes according to some embodiments. In FIG. 6A, operation 600 provides a thermal desorption chamber, such as a container filled with contaminated soil. The thermal desorption chamber can accept an input gas for desorbing the contaminants from the soil. In operation 610, an input gas having a first flow rate and a first temperature is supplied to the thermal desorption chamber. The first flow rate can be provided by a blower assembly having a power or a speed. The first temperature can be provided by a heater assembly having a heating power. In some embodiments, the first temperature can be an optimal temperature for a thermal desorption process. For example, the first temperature can be a maximum temperature that can be provided by the heater assembly, for example, at about 1000 F to 1500 F. In some embodiments, the first flow rate can be an optimal flow rate for a thermal desorption process. For example, the first flow rate can be less than a maximum flow rate of the blower assembly, or less than a flow capacity of the effluent treatment. The first flow rate can also be a maximum flow rate of the blower assembly, or a maximum flow capacity of the effluent treatment.

In operation 620, the first flow rate of the input gas can be increased and/or the first temperature of the input gas can be decreased after a process time or based on an input. In some embodiments, the temperature of the input gas is meant to be the temperature of the input gas before entering the thermal desorption chamber. The input gas can be heated in the thermal desorption chamber, for example, by the oxidation reaction of the hydrocarbon contaminants in the contaminated soil.

In some embodiments, the temperature of the input gas, or the heater power to the heater assembly can be decreased or turned off, e.g., the heater power is turned off and the input gas has the same temperature before entering the heater assembly. The heater power can be decreased, for example, to between 20 and 80% of the previous power. The reduction in power can be based on the thermal energy released by the oxidation of the hydrocarbon contaminants in the contaminated soil.

In some embodiments, the flow rate of the input gas can be increased, for example, to an optimal flow rate for the thermal desorption process, to a maximum flow rate that can be provided by the blower, or to a maximum flow rate that the downstream effluent treatment can handle.

In FIG. 6B, operation 630 provides a thermal desorption chamber, such as a container filled with contaminated soil. In operation 640, input gas characteristics can be controlled, for example, the flow rate and/or the temperature of the input gas, based on inputs from the current thermal desorption process, or from cumulated data from previous processes. Alternatively, the flow rate of the input gas and/or the heater power of the heater assembly can be controlled.

In FIG. 6C, operation 660 provides a thermal desorption chamber, such as a container filled with contaminated soil. In operation 670, input gas characteristics can be adjusted in two or more steps. For example, the flow rate and/or the temperature of the input gas, or the flow rate of the input gas and/or the heater power of the heater assembly, can be adjusted based on inputs from the current thermal desorption process, or from cumulated data from previous processes.

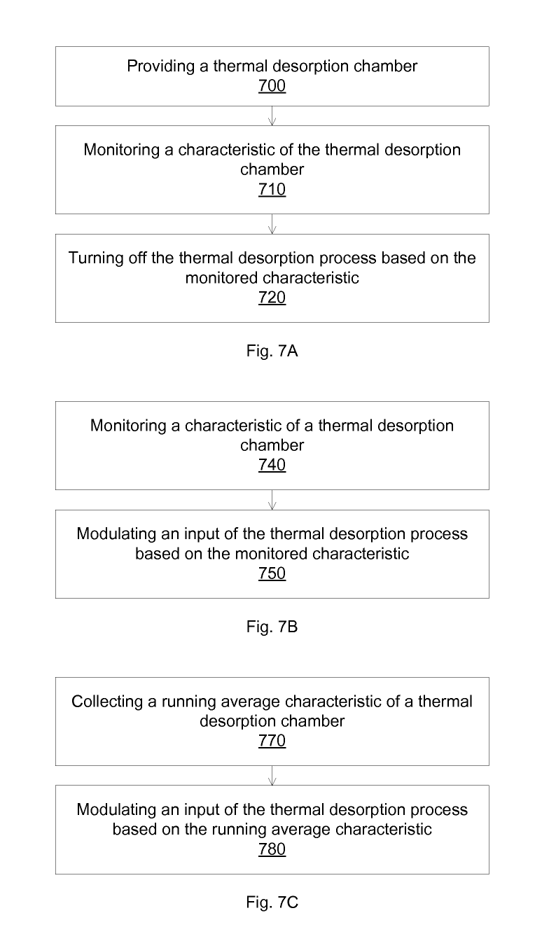

FIGS. 7A-7C illustrate flowcharts for thermal desorption processes according to some embodiments. In FIG. 7A, operation 700 provides a thermal desorption chamber, such as a container filled with contaminated soil. In operation 710, a characteristic of the thermal desorption process is monitored, such as a temperature of the exhaust gas, an oxygen concentration of the exhaust gas, a pressure of the exhaust gas, a gas constituents of the exhaust gas, a humidity of the exhaust gas, a flammability of the of the exhaust gas. In operation 720, the thermal desorption process can be turned off at a time determined by the monitored characteristic. For example, a rate of change of the exhaust gas temperature can be an indication of the time that the treatment can be completed, e.g., the end point of the thermal desorption process, thus a monitoring of the exhaust gas temperature can identify the completion time of the process. Knowing the end point of the process, various inputs to the process (such as flow rate of the input gas, or the heater power of the heater assembly, which can be related to the temperature of the input gas) can be regulated to provide a smooth transition to the end of the process with minimal power consumption and/or fastest throughput.

In FIG. 7B, a feed back operation is provided for the thermal desorption process. In operation 740, a characteristic of a thermal desorption chamber is monitored, such as a temperature of the exhaust gas, an oxygen concentration of the exhaust gas, a pressure of the exhaust gas, a gas constituents of the exhaust gas, a humidity of the exhaust gas, a flammability of the of the exhaust gas. In operation 750, an input to the thermal desorption process can be modulated or regulated based on the monitored characteristics. For example, when the temperature of the exhaust gas reaches a certain temperature, such as between 200 and 220 F, a heater power can be reduced or turned off to reduce the temperature of the input gas. Similarly, a flow rate of the input gas can be increased to increase the reaction rate to provide a faster treatment process.

In FIG. 7C, a feed forward operation is provided for the thermal desorption process. In operation 770, a characteristic of a thermal desorption chamber, e.g., the data from previous thermal desorption processes, is collected. The characteristic can be a running average of the exhaust temperature, or a rate of change of the exhaust temperature. Other characteristics can be collected, such as an oxygen concentration of the exhaust gas, a pressure of the exhaust gas, a gas constituents of the exhaust gas, a humidity of the exhaust gas, a flammability of the of the exhaust gas. In operation 780, an input to the thermal desorption process can be modulated or regulated based on the collected characteristics, such as the running average data.

In some embodiments, behaviors of thermal desorption processes can be used to optimize the performance of the thermal desorption process. For example, different contaminated soils can have different behaviors with respect to the thermal desorption process. For example, high concentration contaminated soil can exhibit oxidation burning characteristics, which can generate a significant thermal energy in the thermal desorption process.

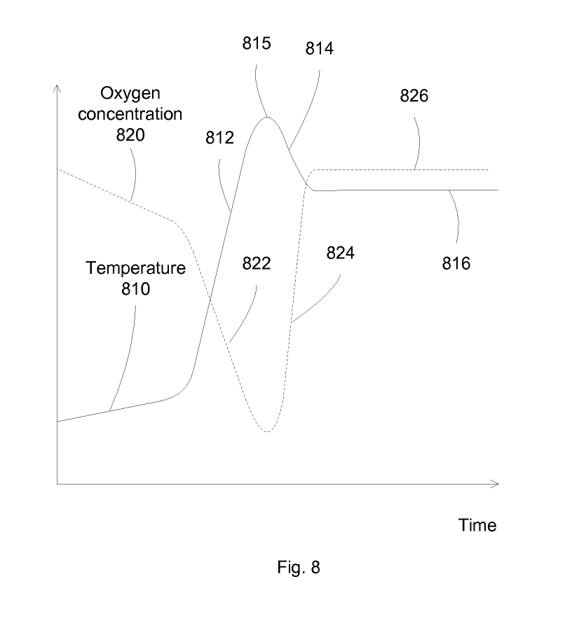

FIG. 8 illustrates temperature and oxygen concentration curves of an exhaust of a thermal desorption process according to some embodiments. The thermal desorption process uses a constant input gas flow rate having a constant temperature for a high concentration contaminated soil. In general, high concentration contaminated soil can have TPH concentration greater than about 50,000 mg/kg. Four distinct regions can be seen. In region 1, the temperature 810 slightly increases, for example, from room temperature to about 200 F. In this region, the soil is heating up. At the end of this region, e.g., about 200 F, visible oil steam can be produced. The oxygen concentration 820 reduces from 21% (for air as input gas) to about 15%, due to the oxidation of the hydrocarbon contaminants in the contaminated soil.

In region 2, the temperature 812 can increase significantly, for example, due to the oxidation of the contaminants. In this region, there is a significant increase in oil steam. The slope of the temperature curve 812 can relate to the contamination concentration, e.g., higher slope (faster temperature rise) for higher concentration soil. The oxygen concentration 822 is further reduced. Since the rate of rise of temperature relates to the contaminate concentration, monitoring this rate of change can allow a determination of the end point of the thermal desorption process. In this region, no heat input (or minimum heat input) can be used, since a portion of the hydrocarbon contaminants can be oxidized, which creates additional heat to vaporize and crack hydrocarbon contaminants. Also, in this region, the reaction of the contaminant can be driven by the input gas flow, thus higher input gas flow can increase the reaction rate, leading to faster completion of the thermal desorption process. At the end of region 2, a peak temperature 815 can be observed. The peak temperature 815 can be calculated from the rate of change of the temperature in this region.

In region 3, the temperature 814 can be reduced while the oxygen concentration 824 increases. In region 4, the reaction is completed, and the temperature 816 reaches the temperature of the input gas while the oxygen concentration also reaches the value of the input gas. This behavior of temperature and oxygen concentration can be used to regulate and optimize the thermal desorption process, for example, to improve the reaction rate to achieve faster throughput and/or to reduce the power consumption.

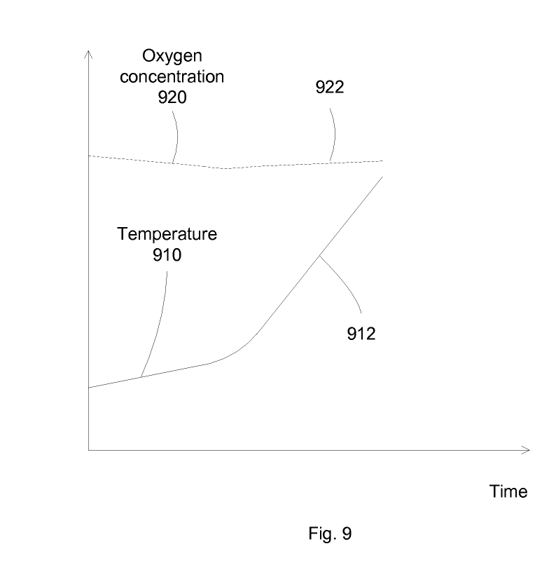

FIG. 9 illustrates temperature and oxygen concentration curves of an exhaust of a thermal desorption process according to some embodiments. The thermal desorption process uses a constant input gas flow rate having a constant temperature for an unsaturated granular soil. Two distinct regions can be seen. In region 1, the temperature 910 slightly increases, for example, from room temperature to about 200 F or 212 F. In this region, the soil is heating up at a certain rate to about 200 F or 212 F. The oxygen concentration 920 slightly reduces. In this region, lighter hydrocarbon contaminants, such as gasoline, are removed before 212 F. In region 2, the rate of change of the temperature 912 changes significantly. In this region, heavy hydrocarbons are removed in sequence, for example, in accordance with the number of carbon atoms in the hydrocarbon chains. The oxygen concentration 922 changes only slightly. Higher input gas flow can increase the reaction rate, leading to faster completion of the thermal desorption process.

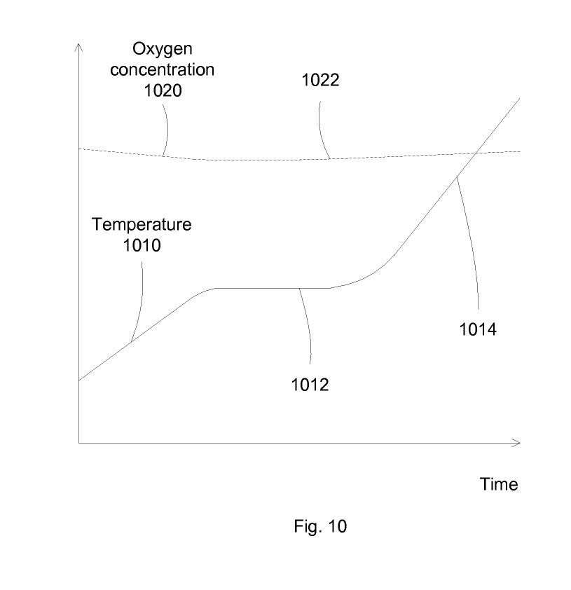

FIG. 10 illustrates temperature and oxygen concentration curves of an exhaust of a thermal desorption process according to some embodiments. The thermal desorption process uses a constant input gas flow rate having a constant temperature for a clay soil, such as saturated soil below water table. Three distinct regions can be seen. In region 1, the temperature 1010 slightly increases, for example, from room temperature to about 200 F. In this region, the soil is heating up at a certain rate to about 200 F or 212 F. The oxygen concentration 1020 slightly reduces. In region 2, the temperature 1012 remains essentially constant. In region 3, the rate of change of the temperature 1014 changes significantly. At about 250 F, chlorinated hydrocarbons can be completely removed. The oxygen concentration 1022 changes only slightly. Higher input gas flow can increase the reaction rate, leading to faster completion of the thermal desorption process.

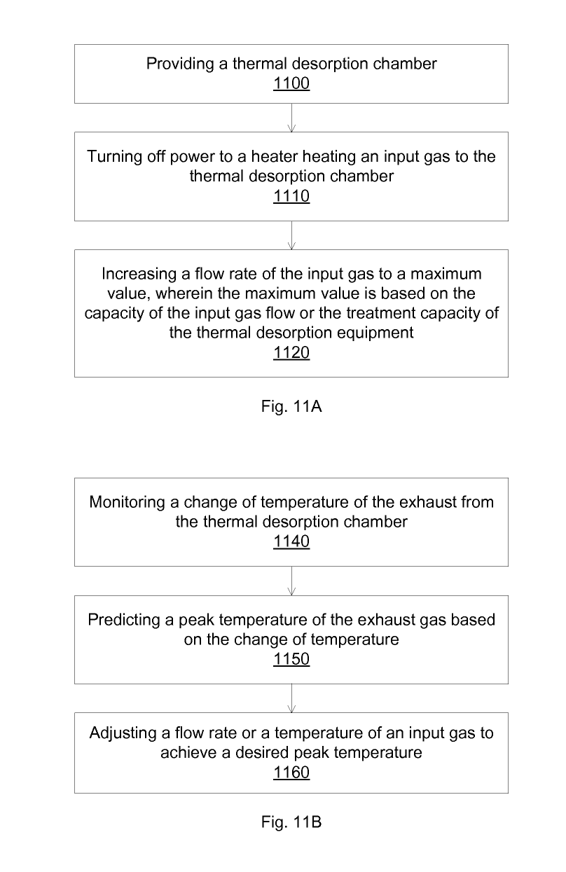

FIGS. 11A-11B illustrate flowcharts for thermal desorption processes according to some embodiments. In FIG. 11A, a process flow for high concentration soil can be provided, in which after an initial heating, for example, for the exhaust gas to reach about 200-220 F, the heating can be supplied by the contaminants in the soil, and thus the input power can be turned off or reduced. Further, the reaction can highly depend on the flow rate, thus a flow rate for the input gas can increase to improve the throughput of the thermal desorption process. Operation 1100 provides a thermal desorption chamber, such as a container filled with contaminated soil. In operation 1110, power to a heater heating an input gas to the thermal desorption chamber is turned off or reduced. For example, the power can be reduced by 20-80%. Alternatively, the temperature of the input gas can be reduced, for example, by 20-80%. In operation 1120, a flow rate of the input gas is increased, for example, to a maximum value, wherein the maximum value is based on the capacity of the input gas flow or the treatment capacity of the thermal desorption equipment.

In FIG. 11B, a process flow for high concentration soil can be provided to prevent temperature of the exhaust gas to be above the safety temperature of the effluent treatment. Operation 1140 monitors a change of temperature of the exhaust from the thermal desorption chamber. Operation 1150 predicts a peak temperature of the exhaust gas based on the change of temperature. Operation 1160 adjusts a flow rate or a temperature of an input gas to achieve a desired peak temperature.

For example, lower flow rate can lower the peak temperature. The flow rate can be reduced by 20-80%. The flow rate can be turned off. Power to a heater heating an input gas to the thermal desorption chamber can be turned off or reduced. For example, the power can be reduced by 20-80%. Alternatively, the temperature of the input gas can be reduced, for example, by 20-80%.

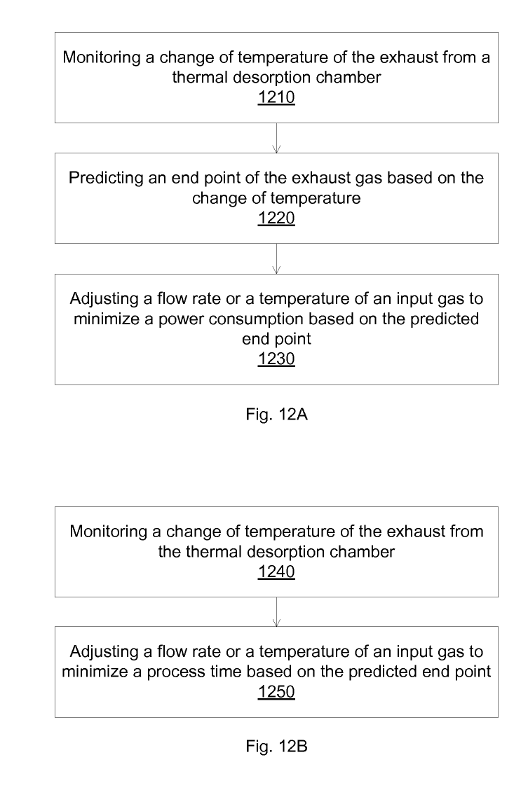

FIGS. 12A-12B illustrate flowcharts for thermal desorption processes according to some embodiments. In FIG. 12A, a process flow for a contaminated soil can be provided, for example, for high concentration or low concentration, for clay soil or for unsaturated granular soil. Operation 1200 monitors a change of temperature of the exhaust from a thermal desorption chamber. Operation 1220 predicts an end point of the exhaust gas based on the change of temperature. Operation 1230 adjusts a flow rate or a temperature of an input gas to minimize power consumption based on the predicted end point. For example, a heater power heating the input gas can be turned off or reduced at a certain time before the end point of the thermal desorption process. The flow rate of the input gas can be turned off. The flow rate can be reduced by 20-80%. The power can be reduced by 20-80%. Alternatively, the temperature of the input gas can be reduced, for example, by 20-80%.

In FIG. 12B, operation 1240 monitors a change of temperature of the exhaust from the thermal desorption chamber. Operation 1250 adjusts a flow rate or a temperature of an input gas to minimize a process time based on the predicted end point. For example, high flow rate or high temperature of the input gas can be used to improve the throughput.

What is claimed is:

1. A method comprising
providing a thermal desorption chamber, wherein the thermal desorption chamber is configured to accept an input gas;
monitoring a change of temperature of an exhaust of the thermal desorption chamber;
predicting an end point of the thermal desorption process based on the change of temperature;
adjusting a flow rate or a temperature of the input gas.

2. A method as in claim 1
wherein the flow rate or the temperature of the input gas is adjusted to minimize a power consumption based on the predicted end point.

3. A method as in claim 1
wherein the flow rate of the input gas is reduced before the predicted end point to minimize a power consumption.

4. A method as in claim 1
wherein the flow rate is reduced by between 20% and 80%.

5. A method as in claim 1
wherein the flow rate of the input gas is turned off before the predicted end point to minimize a power consumption.

6. A method as in claim 1
wherein a heating the input gas is reduced before the predicted end point to minimize a power consumption.

7. A method as in claim 1
wherein the temperature of the input gas is reduced by between 20% and 80%.

8. A method as in claim 1
wherein a heating the input gas is turned off before the predicted end point to minimize a power consumption.

9. A method as in claim 1
wherein the flow rate or the temperature of the input gas is adjusted to minimize a process time of the thermal desorption process.

10. A method as in claim 1
wherein the flow rate or the temperature of the input gas is increased to reduce a process time of the thermal desorption process.

11. A method comprising
providing a thermal desorption chamber, wherein the thermal desorption chamber is configured to accept an input gas;
monitoring a change of temperature of an exhaust of the thermal desorption chamber;
predicting a peak temperature of the exhaust based on the change of temperature;
adjusting a flow rate or a temperature of the input gas to limit the peak temperature to a desired level.

12. A method as in claim 11
wherein the flow rate of the input gas is reduced to lower the peak temperature.

13. A method as in claim 12
wherein the flow rate is reduced by between 20% and 80%.

14. A method as in claim 11
wherein the flow rate of the input gas is turned off to lower the peak temperature.

15. A method as in claim 11
wherein the temperature of the input gas is reduced to lower the peak temperature.

16. A method as in claim 15
wherein the temperature is reduced by between 20% and 80%.

17. A method as in claim 11
wherein adjusting the temperature of the input gas comprises reducing or turning off power of a heater heating the input gas.

18. A method comprising
providing a thermal desorption chamber
heating an input gas using a power level;
supplying a flow of the input gas to the thermal desorption chamber;
reducing the power level;
increasing the flow.

19. A method as in claim 18
wherein reducing the power level comprises turning off the power.

20. A method as in claim 18
wherein the flow increases to a maximum level determined by a capacity of the input gas or by a treatment capacity of the thermal desorption chamber.
